(19) United States
(12) Patent Application Publication
(10) Pub. No.: US 2003/0151299 A1
(43) Pub. Date: Aug. 14, 2003

(54) Vehicle wheel bearing and vehicle wheel stud

(76) Inventors: Gene R. Hawkins, Huron, OH (US); Christopher W. Snavely, Clyde, OH (US)

Correspondence Address: Scott A. McBain, Delphi Technologies, Inc., P.O. Box 5052, Mail Code 480-414-420, Troy, MI, 48007-5052, US

(21) Appl. No.: 10/074,660

(22) Filed: Feb. 13, 2002

(51) Int. Cl. B60B 1/00

(52) U.S. Cl. 301/35.621

(57) ABSTRACT

A vehicle wheel stud and a vehicle wheel bearing including a wheel stud. The vehicle wheel stud includes a vehicle-wheel-stud body. A first portion of the body has wheel-bearing-engaging first external threads, and a second portion of the body has wheel-nut-engaging second external threads. The wheel bearing includes a rotatable section and a wheel stud. The rotatable section includes a hole having internal threads. A first portion of the wheel stud has first external threads threadably attached to the internal threads of the hole. A second portion of the wheel stud has wheel-nut-engaging second external threads.

### TECHNICAL FIELD

The present invention relates generally to vehicles, and more particularly to a vehicle wheel bearing and to a vehicle wheel stud.

### BACKGROUND OF THE INVENTION

Vehicles include automotive vehicles having conventional wheel bearings wherein each wheel bearing includes a non-rotatable section (such as a bearing hub), a rotatable section (such as a bearing spindle) rotatably attached to the non-rotatable section, and wheel studs (also called stud bolts). The non-rotatable section typically is attached to a vehicle suspension system component. In one known design the spindle includes a flange, and a through hole is drilled or punched into the flange. The through hole is slightly smaller in diameter than the stud bolt. The stud bolt is then press fitted into the through hole from the inboard side of the spindle flange until the bolt head is seated against the inboard surface of the spindle flange. A vehicle wheel is then placed on the stud bolts and secured by wheel nuts (also called lug nuts) having internal threads which are threadably attached to the right-hand external threads of the bolt shaft. The bolt shaft has longitudinally-extending serrations engaging the through hole of the spindle flange to prevent the stud bolt from turning during wheel nut assembly or disassembly. The press force exerted on the spindle flange during the press fit operation of the wheel studs typically distorts the outboard surface of the spindle flange causing a small amount of lateral runout. Lateral runout in the spindle flange typically causes brake pulsation and/or other disturbances impeding the performance of the wheel bearing and its neighboring components, as can be appreciated by those skilled in the art. Post assembly process operations have to be performed to correct for lateral runout by smoothing out the outboard surface of the spindle flange, as is known to the artisan.

What is needed is an improved vehicle wheel bearing and an improved vehicle wheel stud.

### SUMMARY OF THE INVENTION

A first expression of an embodiment of the invention is for a vehicle wheel bearing including a vehicle-wheel-bearing non-rotatable section, a vehicle-wheel bearing rotatable section, and a wheel stud. The rotatable section is rotatably attached to the non-rotatable section. The rotatable section has a hole, wherein the hole has internal threads. The wheel stud includes first and second portions. The first portion has first external threads threadably attached to the internal threads of the hole of the rotatable section. The second portion has wheel-nut-engaging second external threads.

A second expression of an embodiment of the invention is for a vehicle wheel bearing including a vehicle-wheel bearing rotatable section and a wheel stud. The rotatable section has a hole, wherein the hole has internal threads. The wheel stud includes first and second portions. The first portion has first external threads threadably attached to the internal threads of the hole of the rotatable section. The second portion has wheel-nut-engaging second external threads.

A third expression of an embodiment of the invention is for a vehicle wheel stud including a vehicle-wheel-stud body. The vehicle-wheel-stud body includes a first portion having wheel-bearing-engaging first external threads and includes a second portion having wheel-nut-engaging second external threads.

Several benefits and advantages are derived from one or more of the expressions of an embodiment of the invention. Having a wheel stud threadably attached to the rotatable section of a wheel bearing eliminates the lateral runout problems of brake pulsation and/or other disturbances impeding the performance of the wheel bearing, encountered by the conventional press fit attachment of a wheel stud to the rotatable section of a wheel bearing. Thus, the threadably attached wheel stud eliminates the need for post-assembly process operations to correct for lateral runout. In one example, the thread direction (i.e., right-hand threads or left-hand threads) of the first and second external threads are chosen so that a wheel nut tightening a vehicle wheel on the wheel stud will tighten the threaded attachment of the wheel stud to the rotatable section of the wheel bearing, as can be appreciated by the artisan.

### SUMMARY OF THE DRAWINGS

FIG. 1 is a schematic perspective view of an embodiment of the invention showing a vehicle wheel bearing including vehicle wheel studs; and

FIG. 2 is a cross sectional view of one of the vehicle wheel studs of FIG. 1 together with a portion of the wheel-bearing spindle of FIG. 1 to which the wheel stud is threadably attached.

### DESCRIPTION OF THE PREFERRED EMBODIMENTS

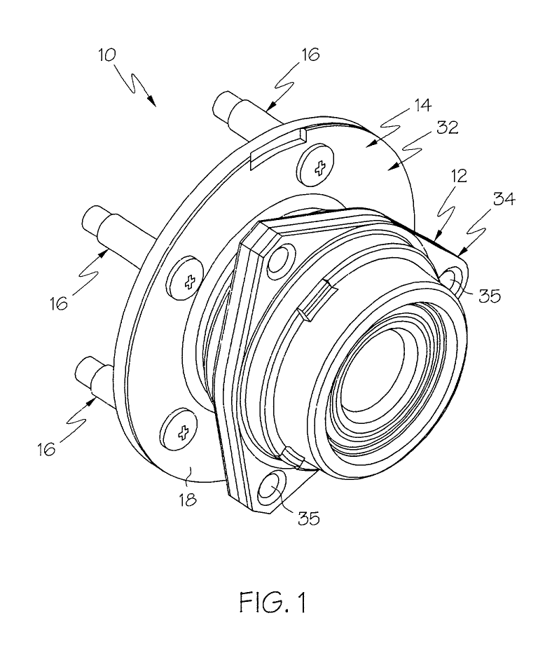

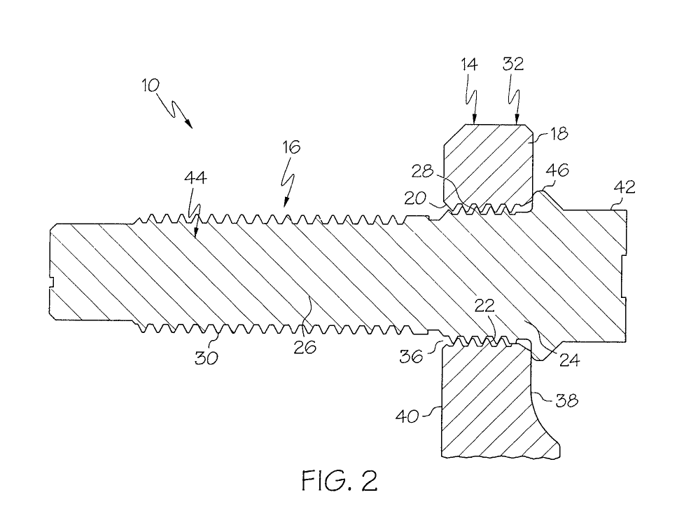

Referring now to the drawings, FIGS. 1 and 2 illustrate an embodiment of the present invention A first expression of the embodiment shown in the figures is for a vehicle wheel bearing 10 including a vehicle-wheel-bearing non-rotatable section 12, a vehicle-wheel-bearing rotatable section 14, and a wheel stud 16. The rotatable section 14 is rotatably attached to the non-rotatable section 12. The rotatable section 14 has a hole 20, and the hole 20 has internal threads 22. The wheel stud 16 includes first and second portions 24 and 26. The first portion 24 has first external threads 28 threadably attached to the internal threads 22 of the hole 20 of the rotatable section 14. The second portion 26 has wheel-nut-engaging second external threads 30.

In one example of the first expression, the rotatable section 14 is a wheel-bearing spindle 32, and the non-rotatable section 12 is a wheel-bearing hub 34 having bolt holes 35 for attaching the hub 34 to a suspension system component such as a knuckle member (not shown). In one design, the rotatable section 14 includes a flange 18, and the flange 18 has the previously-described hole 20. In this design, the hole 20 is a through hole 36, wherein the flange 18 has inboard and outboard sides 38 and 40, wherein the first portion 24 of the wheel stud 16 has a bolt head 42 which is disposed inboard of the inboard side 38 of the flange 18, and wherein the second external threads 30 of the second portion 26 of the wheel stud 16 are disposed outboard of the outboard side 40 of the flange 18. In another design, not shown, the hole need not be a through hole, and the wheel stud is threadably attached to the rotatable section from the outboard side of the flange, as can be appreciated by the artisan.

In one modification of the first expression, most useful when the wheel stud 16 is threadably attached to the rotatable section 14 from the inboard side 38 of the flange 18, the first external threads 28 are oppositely threaded with respect to the second external threads 30. In this modification, a wheel nut (not shown) tightening a vehicle wheel (not shown) on the wheel stud 16 will tighten the threaded attachment of the wheel stud 16 to the rotatable section 14 of the wheel bearing 10, as can be appreciated by the artisan. In one variation, the first external threads 28 are left-hand external threads, and the second external threads 30 are right-hand external threads.

In another modification of the first expression (not shown), most useful when the wheel stud is threadably attached to the rotatable section from the outboard side of the flange, the first external threads are threaded in the same direction as are the second external threads. In this modification, a wheel nut (not shown) tightening a vehicle wheel (not shown) on the wheel stud will tighten the threaded attachment of the wheel stud to the rotatable section of the wheel bearing, as can be appreciated by the artisan. In one variation, the first and second external threads are right-hand external threads.

An alternate first expression of the embodiment shown in the figures is for a vehicle wheel bearing 10 including a vehicle-wheel-bearing non-rotatable hub 34, a vehicle-wheel-bearing rotatable spindle 32, and a wheel stud 16. The spindle 32 is rotatably attached to the hub 34, wherein the spindle 32 includes a flange 18 having a through hole 36 and having inboard and outboard sides 38 and 40, and wherein the through hole 36 has internal threads 22. The wheel stud 16 includes first and second portions 24 and 26. The first portion 24 has first external threads 28 threadably attached to the internal threads 22 of the through hole 36 of the flange 18 of the spindle 32. The second portion 26 has wheel-nut-engaging second external threads 30. The first portion 24 of the wheel stud 16 has a bolt head 42 which is disposed inboard of the inboard side 38 of the flange 18. The second external threads 30 of the second portion 26 of the wheel stud 16 are disposed outboard of the outboard side 40 of the flange 18. The first external threads 28 are left-hand external threads, and the second external threads 30 are right-hand external threads.

In one method for making an example of the vehicle wheel bearing 10, the through hole 36 is drilled in the flange 18 of the spindle 32 and then is tapped for a left-hand thread. The wheel stud 16 would then be threaded into the flange 18 of the spindle 32 using an external or internal drive mechanism located on the bolt head 42 as can be appreciated by the artisan. A portion 46 of the bolt head 42 would be seated against the inboard side 38 of the flange 18 of the spindle 32, and a known amount of torque would be applied to secure the wheel stud 16 to the flange 18 of the spindle 32.

A second expression of the embodiment shown in the figures is for a vehicle wheel bearing 10 including a vehicle-wheel-bearing rotatable section 14 and a wheel stud 16. The rotatable section 14 has a hole 20, and the hole 20 has internal threads 22. The wheel stud 16 includes first and second portions 24 and 26. The first portion 24 has first external threads 28 threadably attached to the internal threads 22 of the hole 20 of the rotatable section 14. The second portion 26 has wheel-nut-engaging second external threads 30.

In one example of the second expression, the rotatable section 14 is a wheel-bearing spindle 32. In one design, the rotatable section 14 includes a flange 18, and the flange 18 has the previously-described hole 20. In this design, the hole 20 is a through hole 36, wherein the flange 18 has inboard and outboard sides 38 and 40, wherein the first portion 24 of the wheel stud 16 has a bolt head 42 which is disposed inboard of the inboard side 38 of the flange 18, and wherein the second external threads 30 of the second portion 26 of the wheel stud 16 are disposed outboard of the outboard side 40 of the flange 18. In another design, not shown, the hole need not be a through hole, and the wheel stud is threadably attached to the rotatable section from the outboard side of the flange, as can be appreciated by the artisan.

In one modification of the second expression, most useful when the wheel stud 16 is threadably attached to the rotatable section 14 from the inboard side 38 of the flange 18, the first external threads 28 are oppositely threaded with respect to the second external threads 30. In this modification, a wheel nut (not shown) tightening a vehicle wheel (not shown) on the wheel stud 16 will tighten the threaded attachment of the wheel stud 16 to the rotatable section 18 of the wheel bearing 10, as can be appreciated by the artisan. In one variation, 10 the first external threads 28 are left-hand external threads, and the second external threads 30 are right-hand external threads.

In another modification of the second expression (not shown), most useful when the wheel stud is threadably attached to the rotatable section from the outboard side of the flange, the first external threads are threaded in the same direction as are the second external threads. In this modification, a wheel nut (not shown) tightening a vehicle wheel (not shown) on the wheel stud will tighten the threaded attachment of the wheel stud to the rotatable section of the wheel bearing, as can be appreciated by the artisan. In one variation, the first and second external threads are right-hand external threads.

A third expression of the embodiment shown in the figures is for a vehicle wheel stud 16 including a vehicle-wheel-stud body 44. The vehicle-wheel-stud body 44 includes first and second portions 24 and 26. The first portion 24 has wheel-bearing-engaging first external threads 28. The second portion 26 has wheel-nut-engaging second external threads 30.

In a first example of the third expression, the first portion 24 has a first diameter at the first external threads 28, the second portion 26 has a second diameter at the second external threads 3O, and the first diameter is larger than the second diameter. In one variation of the first example, the first portion 24 has a bolt head 42, the first external threads 28 are disposed between the bolt head 42 and the second external threads 30, and the bolt head 42 has a portion 46 having a diameter larger than the first diameter. This variation of the first example is most useful when the wheel stud 16 is to be threadably attached, via the first external threads 28, to a rotatable section 14 of a vehicle wheel bearing 10 from the inboard side 38 of the flange 18 of the rotatable section 14. In a second example, not shown, the first diameter is smaller or larger than the second diameter, the second portion has a bolt head having a diameter smaller than the second external threads, and the second external threads are disposed between the bolt head and the first external threads. This second example is most useful when the wheel stud is to be threadably attached, via the first external threads, to the rotatable section from the outboard side of the flange.

In a first construction of the third expression, the first external threads 28 are oppositely threaded with respect to the second external threads 30. This first construction is most useful when using the previously-described first example of the third expression wherein a wheel nut (not shown) tightening a vehicle wheel (not shown) on the wheel stud 16 will tighten the threaded attachment of the wheel stud 16 to the rotatable section 14 of the wheel bearing 10, as can be appreciated by the artisan. In one variation, the first external threads 28 are left-hand external threads, and the second external threads 30 are right-hand external threads. In a second construction of the third expression, not shown, the first external threads are threaded in the same direction as are the second external threads. This second construction is most useful when using the previously-described second example of the third expression wherein a wheel nut (not shown) tightening a vehicle wheel (not shown) on the wheel stud will tighten the threaded attachment of the wheel stud to the rotatable section of the wheel bearing, as can be appreciated by the artisan. In one variation, the first and second external threads are right-hand external threads.

Several benefits and advantages are derived from one or more of the expressions of an embodiment of the invention. Having a wheel stud threadably attached to the rotatable section of a wheel bearing eliminates the lateral runout problems of brake pulsation and/or other disturbances impeding the performance of the wheel bearing, encountered by the conventional press fit attachment of a wheel stud to the rotatable section of a wheel bearing. Thus, the threadably attached wheel stud eliminates the need for post-assembly process operations to correct for lateral runout. In one example, the thread direction (i.e., right-hand threads or left-hand threads) of the first and second external threads are chosen so that a wheel nut tightening a vehicle wheel on the wheel stud will tighten the threaded attachment of the wheel stud to the rotatable section of the wheel bearing, as can be appreciated by the artisan.

The foregoing description of several expressions of an embodiment of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

1. A vehicle wheel bearing comprising:
a) a vehicle-wheel-bearing non-rotatable section;
b) a vehicle-wheel-bearing rotatable section rotatably attached to the non-rotatable section, wherein the rotatable section has a hole, and wherein the hole has internal threads; and
c) a wheel stud including first and second portions, wherein the first portion has first external threads threadably attached to the internal threads of the hole of the rotatable section, and wherein the second portion has wheel-nut-engaging second external threads.

2. The vehicle wheel bearing of claim 1, wherein the rotatable section is a wheel-bearing spindle, and wherein the non-rotatable section is a wheel-bearing hub.

3. The vehicle wheel bearing of claim 1, wherein the rotatable section includes a flange, wherein the flange has the hole, wherein the hole is a through hole, wherein the flange has inboard and outboard sides, wherein the first portion of the wheel stud has a bolt head which is disposed inboard of the inboard side of the flange, and wherein the second external threads of the second portion of the wheel stud are disposed outboard of the outboard side of the flange.

4. The vehicle wheel bearing of claim 3, wherein the first external threads are oppositely threaded with respect to the second external threads.

5. The vehicle wheel bearing of claim 4, wherein the first external threads are left-hand external threads, and wherein the second external threads are right-hand external threads.

6. The vehicle wheel bearing of claim 5, wherein the rotatable section is a wheel-bearing spindle, and wherein the non-rotatable section is a wheel-bearing hub.

7. A vehicle wheel bearing comprising:
a) a vehicle-wheel-bearing non-rotatable hub;
b) a vehicle-wheel-bearing rotatable spindle rotatably attached to the non-rotatable section, wherein the spindle includes a flange having a through hole and having inboard and outboard sides, and wherein the through hole has internal threads; and
c) a wheel stud including first and second portions, wherein the first portion has first external threads threadably attached to the internal threads of the through hole of the flange of the spindle, wherein the second portion has wheel-nut-engaging second external threads, wherein the first portion of the wheel stud has a bolt head which is disposed inboard of the inboard side of the flange, wherein the second external threads of the second portion of the wheel stud are disposed outboard of the outboard side of the flange, wherein the first external threads are left-hand external threads, and wherein the second external threads are right-hand external threads.

8. A vehicle wheel bearing comprising:
a) a vehicle-wheel-bearing rotatable section having a hole, wherein the hole has internal threads; and
b) a wheel stud including first and second portions, wherein the first portion has first external threads threadably attached to the internal threads of the hole of the rotatable section, and wherein the second portion has wheel-nut-engaging second external threads.

9. The vehicle wheel bearing of claim 8, wherein the rotatable section is a wheel-bearing spindle.

10. The vehicle wheel bearing of claim 8, wherein the rotatable section includes a flange, wherein the flange has the hole, wherein the hole is a through hole, wherein the flange has inboard and outboard sides, wherein the first portion of the wheel stud has a bolt head which is disposed inboard of the inboard side of the flange, and wherein the second external threads of the second portion of the wheel stud are disposed outboard of the outboard side of the flange.

11. The vehicle wheel bearing of claim 10, wherein the first external threads are oppositely threaded with respect to the second external threads.

12. The vehicle wheel bearing of claim 11, wherein the first external threads are left-hand external threads, and wherein the second external threads are right-hand external threads.

13. The vehicle wheel bearing of claim 12, wherein the rotatable section is a wheel-bearing spindle.

14. A vehicle wheel stud comprising a vehicle-wheel-stud body including a first portion having wheel-bearing-engaging first external threads and including a second portion having wheel-nut-engaging second external threads.

15. The vehicle wheel stud of claim 14, wherein the first external threads are oppositely threaded with respect to the second external threads.

16. The vehicle wheel stud of claim 14, wherein the first portion has a first diameter at the first external threads, wherein the second portion has a second diameter at the second external threads, and wherein the first diameter is larger than the second diameter.

17. The vehicle wheel stud of claim 16, wherein the first portion has a bolt head, wherein the first external threads are disposed between the bolt head and the second external threads, and wherein the bolt head has a portion having a diameter larger than the first diameter.

18. The vehicle wheel stud of claim 17, wherein the first external threads are oppositely threaded with respect to the second external threads.

19. The vehicle wheel stud of claim 18, wherein the first external threads are left-hand external threads, and wherein the second external threads are right-hand external threads.

20. A vehicle wheel stud comprising a vehicle-wheel-stud body including a first portion having wheel-bearing-engaging first external threads and including a second portion having wheel-nut-engaging second external threads, wherein the first portion has a first diameter at the first external threads, wherein the second portion has a second diameter at the second external threads, wherein the first diameter is larger than the second diameter, wherein the first portion has a bolt head, wherein the first external threads are disposed between the bolt head and the second external threads, wherein the bolt head has a portion having a diameter larger than the first diameter, wherein the first external threads are left-hand external threads, and wherein the second external threads are right-hand external threads.
